(19) United States
(12) Patent Application Publication
(10) Pub. No.: US 2003/0131924 A1
(43) Pub. Date: Jul. 17, 2003

(54) Method and device for making tubular object of composite material

(76) Inventor: Chuan-An Hsiao, Taichung (TW)

Correspondence Address: CHUAN-AN HSIAO, P.O. BOX 453, TAICHUNG, TW

(21) Appl. No.: 10/047,401

(22) Filed: Jan. 16, 2002

(51) Int. Cl. B31C 1/00

(52) U.S. Cl. 156/184; 156/191; 264/511; 264/512

(57) ABSTRACT

A method for forming a tubular object of a composite material involves a first step in which a composite material layer is wound around an iron bar. The iron bar and the composite material layer are then fitted into a contractible plastic covering. The composite material layer is formed into a tubular object in a vacuum chamber into which a thermal medium is introduced. The tubular object is separated from the plastic covering by an air injection between the tubular object and the plastic covering. The iron bar is finally extracted from the tubular object.

### BACKGROUND OF THE INVENTION

1. Field of the Invention

The present invention relates generally to a tubular object made of a composite material, and more particularly to method and device for making such tubular object.

2. Description of Related Art

As shown in FIG. 5, the conventional method for making a tubular object of a composite material involves the use of an iron core 30 which is provided with a composite material 31 wound therearound. The composite material 31 is provided with a ribbon of a compressible plastic film 32, which is wound around the composite material 31 such that the overlapping portion of the compressible plastic film 32 forms a difference of elevation. In other words, a void 320 is formed at the juncture of the plastic film 32 and the composite material 31. In the wake of the heat process, the molten composite material 31 is bound to be extruded by the compression force of the plastic film 32 such that a portion of the molten composite material 31 is forced to the void 320, thereby resulting in formation of a tubular object which is uneven in surface. As a result, the tubular object must be finished at an extra cost. In addition, the winding processes of the conventional method are labor-intensive and are therefore not cost-effective. The tubular object is inherently defective in design in that the plastic film 32 is apt to strip off the composite material 31. Furthermore, the compressible plastic film 32 is costly and can not be recycled.

### BRIEF SUMMARY OF THE INVENTION

The primary objective of the present invention is to provide a cost-effective method for making a high-quality tubular object of a composite material.

In keeping with the principle of the present invention, the foregoing objective of the present invention is attained by a method in which a composite material layer is wound around an iron core before the iron core is put into a plastic jacket. The iron core is then provided with a film cap and a film base. The tubular object is formed in a vacuum chamber in conjunction with a thermal medium.

The features and the advantages of the present invention will be more readily understood upon a thoughtful deliberation of the following detailed description of the present invention with reference to the accompanying drawings.

### BRIEF DESCRIPTION OF THE SEVERAL VIEWS OF THE DRAWINGS

FIG. 1 shows a process flow diagram of the present invention.

FIG. 2 shows a sectional view of a process chamber of the present invention.

FIG. 3 shows a longitudinal sectional view of the iron core, the composite material layer, and the plastic covering of the present invention.

FIG. 4 shows an enlarged sectional view of the iron core, the composite material layer and the plastic covering of the present invention.

FIG. 5 shows an enlarged sectional view of the iron core, the composite material and the plastic film of the prior art.

### DETAILED DESCRIPTION OF THE INVENTION

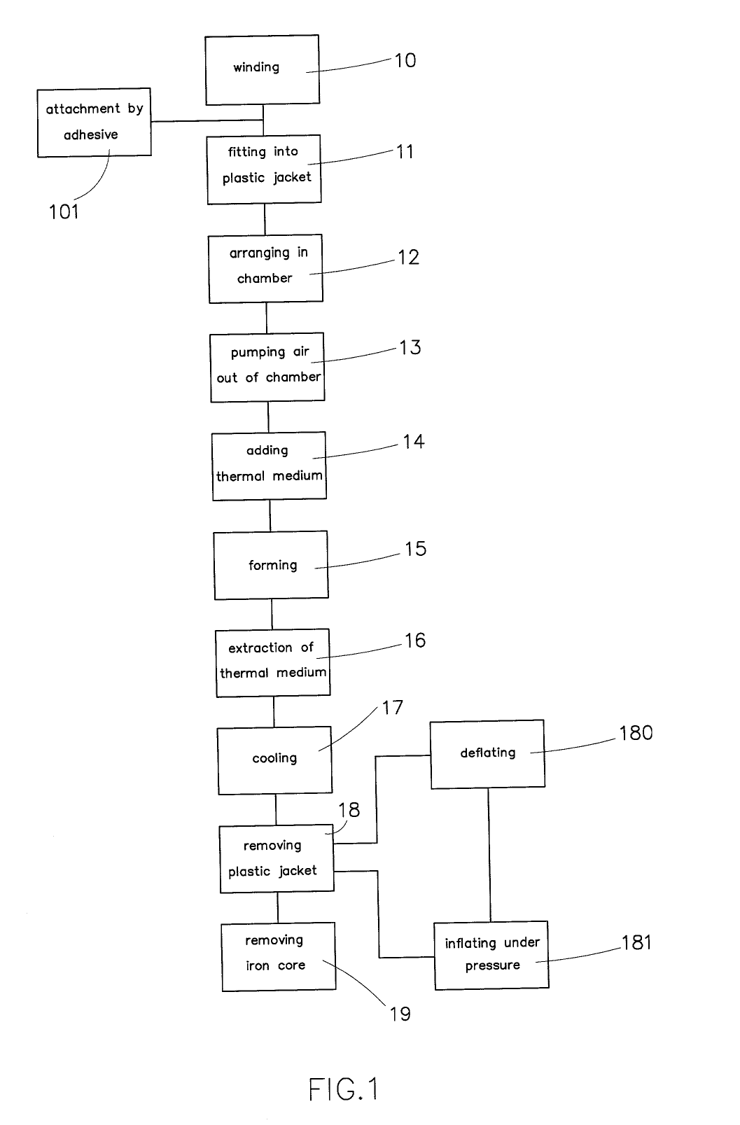

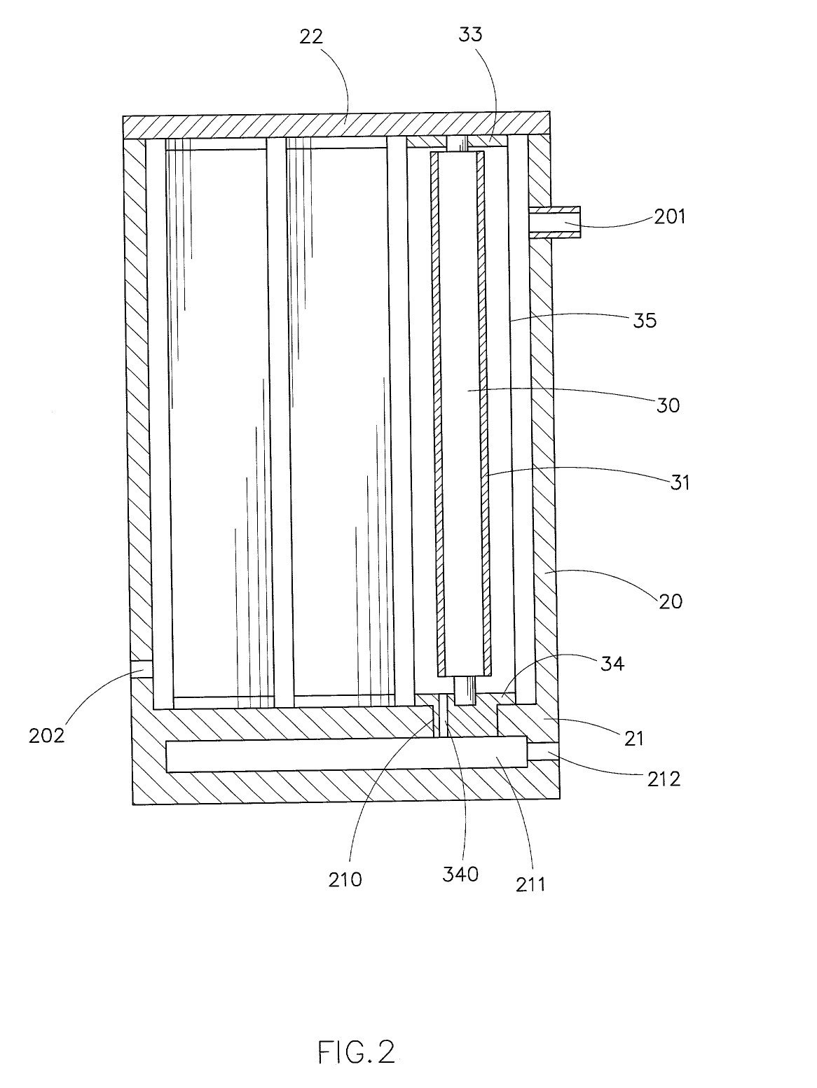

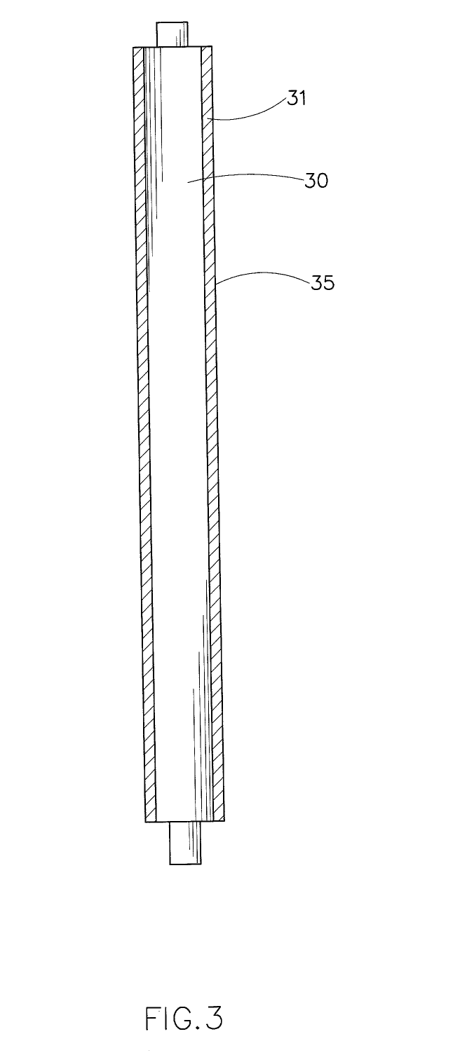

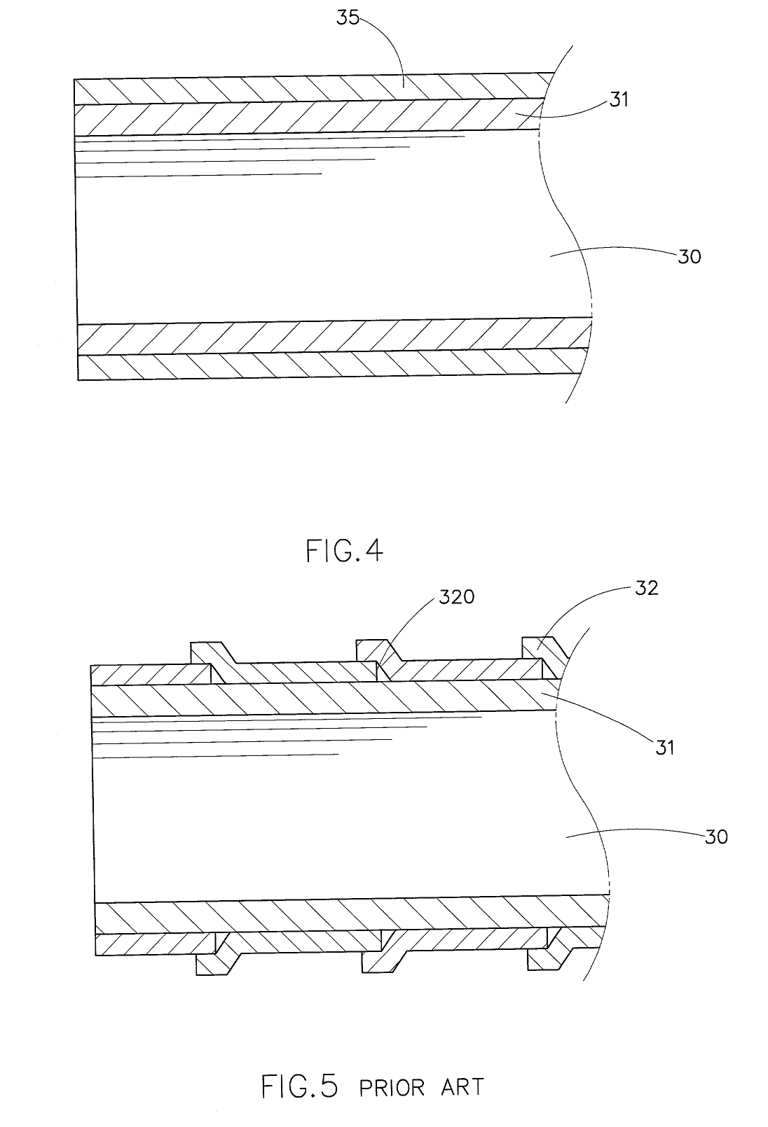

As illustrated in FIGS. 1-4, a method embodied in the present invention is intended to make a tubular object of a composite material.

The method of the present invention involves a first step in which an iron bar 30 is provided with a composite material layer 31 wound therearound. The iron bar 30 is then provided with a plastic covering 35 embracing the composite material layer 31. In the meantime, the iron bar 30 is provided at the top end with a film cap 33, and at the bottom end with a film base 34. The outer edges of the film cap 33 and the film base 34 are fitted into the open ends of the plastic covering 35, thereby enabling the composite material layer 31 to be completely enclosed in the plastic covering 35. As a result, a preliminary product is formed.

The preliminary product is then arranged in a process chamber 20 which is provided with an inlet 201 and an outlet 202. The chamber 20 is further provided in the bottom with a base portion 21 which is in turn provided with an inner threaded hole 210 engaging the outer threaded portion of the film base 34. The film base 34 is provided with a ventilation hole 340 in communication with a connection cell 211 of the base portion 21. The connection cell 211 is provided in the side wall with an air-pumping port 212 to facilitate the pumping of air out of the process chamber 20. As a result, air existing between the plastic covering 35 and the composite material layer 31 is exhausted by suction so as to enable the plastic covering 35 to be in an intimate contact with the composite material layer 31. As a result, an intermediate product is formed.

A thermal medium is subsequently introduced into the process chamber 20 via the inlet 201. The thermal medium serves to enable the plastic covering 35 to contract so as to attach intimately to the composite material layer 31. In the presence of heat, the composite material layer 31 is fused with the plastic covering 35. Upon completion of the fusion process, the thermal medium is withdrawn from the process chamber 20 via the outlet 202. A cooling agent is then injected into the process chamber 20 for cooling the product so made. The product so made is a tubular object of the composite material 31. The tubular object is embraced by the plastic covering 35.

The separation of the tubular object from the plastic covering 35 is brought about by a deflation process 180 and an inflation process 181. The deflation process 180 refers to an act by which the suction pump is shut off. The inflation process 181 refers to an act by which air is injected between the plastic covering 35 and the composite material 31, thereby resulting in separation of the plastic covering 35 from the tubular object of the composite material 31.

Finally, the iron bar 30 is extracted from the tubular object of the composite material 31.

The tubular object so made is even in surface. In addition, the tubular object can be made in quantity, thanks to the large capacity of the process chamber 20. Furthermore, the plastic covering 35 of the method of the present invention is recyclable, thereby resulting in reduction in production cost.

It must be noted that the composite material layer 31 may be wound around the iron bar 30 such that the outer surface of the composite material layer 31 is provided with an adhesive coating by means of which the plastic covering 35 is rolled up to the composite material layer 31.

The plastic covering 35 of the present invention is contractible and is initially smaller in diameter than the iron bar 30. Before the iron bar 30 is fitted into the plastic covering 35, the entry end of the plastic covering 35 is enlarged in its inner diameter by blowing, so as to facilitate the fitting of the iron bar 30 into the plastic covering 35 without causing the plastic covering 35 to wrinkle. Upon completion of the entire process, the plastic covering 35 is inflated to result in separation of the plastic covering 35 from the iron bar 30.

The present invention described above is to be regarded in all respects as being illustrative and nonrestrictive. Accordingly, the present invention may be embodied in other specific forms without deviating from the spirit thereof. The present invention is therefore to be limited only by the scopes of the following claims.

I claim:

1. A method for making a tubular object of a composite material, said method comprising the steps of:
(a) winding a composite material layer around the outer surface of an iron bar;
(b) fitting a contractible plastic covering over the iron bar along with the composite material layer, so as to form a preliminary product;
(c) arranging the preliminary product in a chamber of a process device before the chamber is exhausted of air by a suction pump, thereby resulting in removal of air existing between the composite material layer and the plastic covering so as to enable the plastic covering to make an intimate contact with the composite material layer;
(d) introducing a thermal medium into the chamber to cause the composite material layer to form into a tubular object;
(e) removing the thermal medium from the chamber;
(f) cooling the tubular object with a cooling medium;
(g) separating the plastic covering from the tubular object by injecting air between the plastic covering and the tubular object; and
(h) extracting the iron bar from the tubular object.

2. The method as defined in claim 1, wherein the iron bar is provided at a top end with a film cap, and at a bottom end with a film base, with the outer edges of the film cap and the film base being inserted into open ends of the plastic covering, and with the composite material layer being enclosed in the plastic covering; wherein the chamber is provided with an inlet, an outlet, and a base portion which is fastened with the film base whereby the film base is provided with a ventilation hole in communication with a connection cell of the base portion, the connection cell being provided with an air-pumping port to facilitate the pumping of air out of the chamber.

3. The method as defined in claim 1, wherein the composite material layer of the step (a) is provided with an adhesive coating by which the plastic covering of the step (b) is rolled up to the composite plastic layer.
